(19) United States
(12) Patent Application Publication
(10) Pub. No.: US 2013/0194823 A1
(43) Pub. Date: Aug. 1, 2013

(54) BACKLIGHT UNIT

(71) Applicants: Shugo Yagi, Yonago-shi (JP); Takeshi Suzuki, Yonago-shi (JP); Toru Inata, Yonago-shi (JP)

(72) Inventors: Shugo Yagi, Yonago-shi (JP); Takeshi Suzuki, Yonago-shi (JP); Toru Inata, Yonago-shi (JP)

(73) Assignee: SHARP KABUSHIKI KAISHA, Osaka-shi, Osaka (JP)

(21) Appl. No.: 13/878,806

(22) PCT Filed: Oct. 12, 2011
(86) PCT No.: PCT/JP2011/073408

§ 371 Date: Apr. 11, 2013

(30) Foreign Application Priority Data
Oct. 15, 2010 (JP) 2010-232422

(51) Int. Cl. F21V 8/00

(52) U.S. Cl. CPC G02B 6/005
USPC 362/607

(57) ABSTRACT

A backlight unit includes a light source capable of emitting light, and a light guide plate including a peripheral surface on which the light from the light source is incident, a main surface provided to be connected with the peripheral surface, and a main surface facing the main surface with the peripheral surface interposed therebetween, the light guide plate including a reflection surface capable of reflecting the light that has entered from the peripheral surface toward the main surface, and a lens formed on the main surface capable of condensing the light reflected by the reflection surface and emitting the light to outside.

### TECHNICAL FIELD

The present invention relates to backlight units.

### BACKGROUND ART

A liquid crystal display device is provided in electronic devices such as mobile phone devices, digital cameras, portable game machines, car navigation systems, personal computers, and flat-screen televisions. A liquid crystal display device is a display device without a self light-emitting function, and is thus used together with a backlight system that emits light from a back surface. As the backlight system, an edge light type backlight having a light source provided at an edge portion of a light guide plate, and a directly-below type backlight having a light source provided directly below a display screen are used. The edge light type backlight is a system where light incident from the edge portion of the light guide plate is diffused to be uniform in a display area by the light guide plate and exits from one main surface. Such an edge light type backlight includes a reflection sheet laminated on the other main surface side of the light guide plate, a diffusion sheet laminated on the one main surface side serving as an exit surface, and two prism sheets arranged on the diffusion sheet.

In recent years, there has been an increasing demand for thinner liquid crystal display devices, with various proposals being made for reducing the thickness of the edge light type backlight unit.

For example, a backlight described in Japanese Patent Laying-Open No. 2006-331958 includes a light guide plate, a plurality of LED light sources arranged to face a light incident side surface of the light guide plate, a diffusion sheet arranged on an upper surface of the light guide plate, and a prism sheet arranged on an upper surface of the diffusion sheet. The prism sheet includes a plurality of prisms having a ridge line in a direction parallel to the light incident side surface.

### CITATION LIST

### Patent Document

PTD 1: Japanese Patent Laying-Open No. 2006-331958

### SUMMARY OF INVENTION

### Technical Problem

The backlight described in Japanese Patent Laying-Open No. 2006-331958 has the diffusion sheet provided on the upper surface of the light guide plate, and does not have a sufficiently reduced thickness.

The present invention was made in view of the problems as described above, and an object of the present invention is to provide a backlight unit having a reduced thickness.

### Solution to Problem

A backlight unit according to the present invention includes a light source capable of emitting light, and a light guide body including a peripheral surface on which the light from the light source is incident, a first main surface provided to be connected with the peripheral surface, and a second main surface facing the first main surface with the peripheral surface interposed therebetween.

The light guide body includes a reflection surface capable of reflecting the light that has entered from the peripheral surface toward the second main surface, and a lens formed on the second main surface capable of condensing the light reflected by the reflection surface and emitting the light to outside.

Preferably, the peripheral surface includes an incident surface on which the light from the light source is incident and which has a first end portion and a second end portion, a first side surface provided to be connected with the first end portion of the incident surface, a second side surface provided to be connected with the second end portion of the incident surface, and an end surface positioned opposite to the incident surface. The reflection surface includes a plurality of unit reflection surfaces spaced apart from one another in a direction from the incident surface toward the end surface.

Preferably, the unit reflection surfaces are formed to extend in a direction from the first side surface toward the second side surface.

Preferably, the unit reflection surfaces are arranged such that spaces between the unit reflection surfaces are reduced in the direction from the incident surface toward the end surface.

Preferably, the first main surface is provided with a groove, and the unit reflection surface is a surface of an inner surface of the groove facing the incident surface. Preferably, the bottom surface first main surface is provided with an opening of the bottom surface groove, and the inner surface of the bottom surface groove includes a bottom surface facing the bottom surface opening, the unit reflection surface connected with the bottom surface bottom surface and facing the bottom surface incident surface, and an inner side surface connected with the bottom surface bottom surface and facing the bottom surface unit reflection surface. The inner surface of the groove is formed such that the distance between the unit reflection surface and the inner side surface is increased from the bottom surface toward the opening.

Preferably, the first main surface is provided with a plurality of convex portions projecting from the first main surface, and the unit reflection surface is a surface of surfaces of the convex portion facing the incident surface. Preferably, the convex portions are arranged in the direction from the incident surface toward the end surface, and the plurality of convex portions are formed such that an angle between the unit reflection surface and an imaginary plane through the first main surface is increased in the direction from the incident surface toward the end surface.

Preferably, the peripheral surface includes an incident surface on which the light from the light source is incident and which has a first end portion and a second end portion, a first side surface provided to be connected with the first end portion of the incident surface, a second side surface provided to be connected with the second end portion of the incident surface, and an end surface positioned opposite to the incident surface. The lens includes a plurality of unit lenses arranged in the direction from the first side surface toward the second side surface.

Preferably, the unit lenses are formed to extend from the incident surface to the end surface. Preferably, the peripheral surface includes an incident surface on which the light from the light source is incident and which has a first end portion and a second end portion, a first side surface provided to be connected with the first end portion of the incident surface, a second side surface provided to be connected with the second end portion of the incident surface, and an end surface positioned opposite to the incident surface. The first main surface is inclined away from the second main surface in the direction from the incident surface toward the end surface.

Preferably, the backlight unit further includes a reflection sheet arranged on the first main surface, and a prism sheet arranged on the second main surface. The prism sheet includes a plurality of prisms extending in the direction from the incident surface toward the end surface.

Preferably, the backlight unit further includes a reflection sheet arranged on the second main surface, and a prism sheet arranged on the first main surface. The prism sheet includes a plurality of prisms extending in the direction from the incident surface toward the end surface.

### Advantageous Effects of Invention

According to the backlight unit of the present invention, the thickness of the backlight unit can be reduced.

### BRIEF DESCRIPTION OF DRAWINGS

FIG. 1 is an exploded perspective view showing a liquid crystal display device equipped with a backlight unit according to this embodiment.

FIG. 2 is an exploded perspective view of a backlight unit 3.

FIG. 3 is a perspective view showing a light guide plate 10.

FIG. 4 is a side view showing light guide plate 10 and a light source.

FIG. 5 is a side view showing the details of a prism groove 26.

FIG. 6 is a side view showing a variation of a unit reflection surface 24 shown in FIG. 5.

FIG. 7 is a side view of backlight unit 3.

FIG. 8 is a cross-sectional view of light guide plate 10, showing a cross section in a position through a flat portion 29 between prism grooves 26.

FIG. 9 is a cross-sectional view of light guide plate 10, schematically showing how light L2 travels.

FIG. 10 is a side view of backlight unit 3.

FIG. 11 is a cross-sectional view showing a prism sheet 12.

FIG. 12 is a side view showing a variation of light guide plate 10.

FIG. 13 is a schematic diagram showing a state where light L1 from an LED 13a is reflected by flat portion 29.

FIG. 14 is a schematic diagram showing a state where reflected light of light L1 shown in FIG. 13 reaches a main surface 14 and reflected light of light L1A reaches main surface 14.

FIG. 15 is a side view showing a variation of backlight unit 3.

FIG. 16 is a side view showing a variation of prism groove 26.

FIG. 17 is a side view showing a variation of a convex portion 35 shown in FIG. 6.

FIG. 18 is a graph showing relation between a distance Q between convex portion 35 and an incident surface 17 ((mm):(prism position)), and an inclination angle θ6 and a crossing angle θ7.

FIG. 19 shows a simulation result of a backlight unit model according to this embodiment.

FIG. 20 is a graph showing an area ratio of regions of high luminance and low luminance in a model 80 shown in FIG. 19.

FIG. 21 is a perspective view schematically showing model 80, illustrating a coordinate system that displays the distribution of light exit angles that will be described later.

FIG. 22 is a plan view of the coordinate system shown in FIG. 21.

FIG. 23 is a simulation result showing the distribution of exit angles in model 80 shown in FIG. 21.

FIG. 24 is a graph showing an area ratio of each luminance.

FIG. 25 is a schematic diagram showing a state where a coordinate system other than that shown in FIG. 21 is applied to model 80.

FIG. 26 is a graph showing simulation results of a view angle d and luminance, when an inclination angle b shown in FIG. 5 was changed.

FIG. 27 is a graph showing relation between view angle d and luminance, when an apex angle c shown in FIG. 11 was changed as appropriate.

FIG. 28 is an exploded perspective view showing a backlight model 50 as a comparative example.

FIG. 29 is a side view schematically showing backlight model 50 shown in FIG. 28.

FIG. 30 is an experimental result showing the distribution of exit angles of light emitted from an upper surface of a light guide plate 52.

FIG. 31 is an experimental result showing the distribution of exit angles of light emitted from a diffusion sheet 53.

FIG. 32 is an experimental result showing the distribution of exit angles of light emitted from a prism sheet 54.

FIG. 33 is an experimental result showing the distribution of exit angles of light emitted from a prism sheet 55.

FIG. 34 is an experimental result showing the distribution of exit angles of light emitted from a backlight unit having light guide plate 52 and prism sheet 54 laminated on one another.

### DESCRIPTION OF EMBODIMENTS

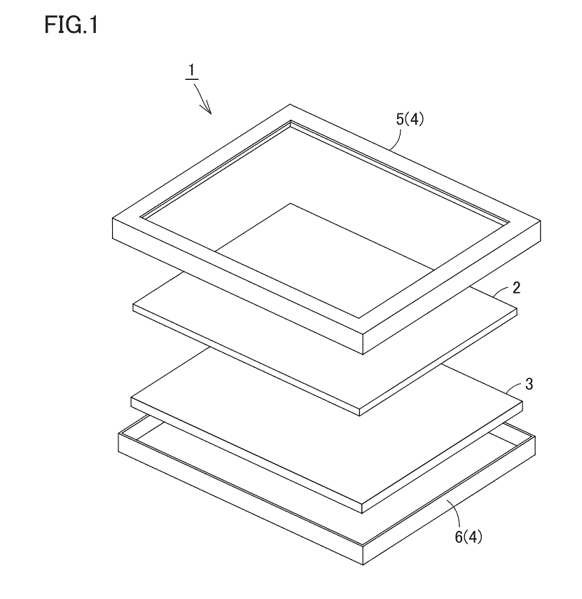

Referring to FIGS. 1 to 34, a backlight according to the present invention is described. Whenever any reference is made to a number, amount and the like in embodiments described below, the scope of the present invention is not necessarily limited to that number, amount and the like unless otherwise specified. Moreover, in the following embodiments, each constituent element is not a requirement of the present invention unless otherwise specified. Furthermore, if there are a plurality of embodiments below, it is originally intended to combine features of the embodiments together as appropriate unless otherwise specified.

FIG. 1 is an exploded perspective view showing a liquid crystal display device equipped with a backlight unit according to this embodiment.

As shown in FIG. 1, a liquid crystal display device 1 includes a liquid crystal display panel 2, a backlight unit 3 for irradiating liquid crystal display panel 2 with light, and a bezel 4 forming an outer frame of liquid crystal display device 1. Bezel 4 includes a front bezel 5 and a rear bezel 6. Front bezel 5 is provided with a window portion such that a screen of liquid crystal display panel 2 is viewable from outside.

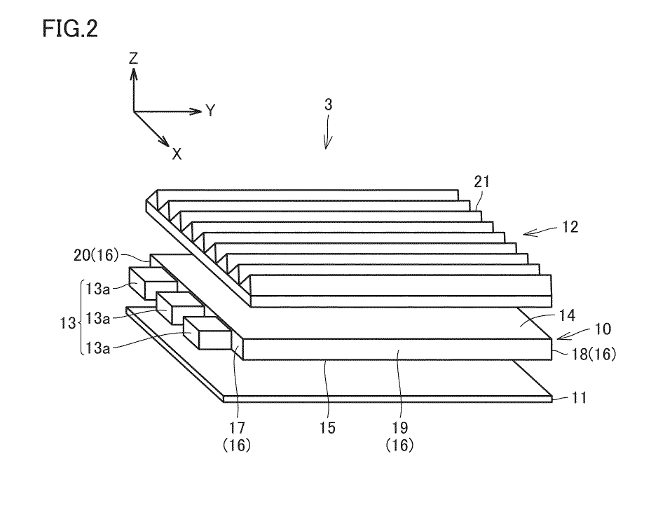

FIG. 2 is an exploded perspective view of backlight unit 3. Backlight unit 3 shown in FIG. 2 is an edge light type backlight unit, and includes a light guide plate 10, a reflection sheet 11, a prism sheet 12, and a light source 13 for irradiating light guide plate 10 with light.

Light guide plate 10 is formed in the shape of a plate, and includes a main surface 14, a main surface 15 arranged to face main surface 14, and a peripheral surface 16 provided to be connected with an outer edge portion of each of main surface 15 and main surface 14. Peripheral surface 16 includes an incident surface 17 on which light source 13 is provided, an end surface 18 positioned opposite to incident surface 17, a side surface 19 connected with one end portion of incident surface 17, and a side surface 20 connected with the other end portion of incident surface 17. Peripheral surface 16 is interposed between main surface 14 and main surface 15.

Light source 13 is provided on incident surface 17 which is part of peripheral surface 16, and emits light from incident surface 17 into light guide plate 10. Light source 13 includes a plurality of LEDs (Light-Emitting Diodes) 13a spaced apart from one another on incident surface 17. It is noted that another light source device such as fluorescent tubes may be employed instead of the LEDs.

Prism sheet 12 is provided on main surface 14 of light guide plate 10. Of the surfaces of prism sheet 12, a main surface facing main surface 14 is formed as a flat surface, and a plurality of prisms 21 are formed on a main surface positioned opposite to this flat main surface.

Prisms 21 are formed to extend from incident surface 17 to end surface 18 of light guide plate 10. The plurality of prisms 21 are arranged from side surface 19 toward side surface 20.

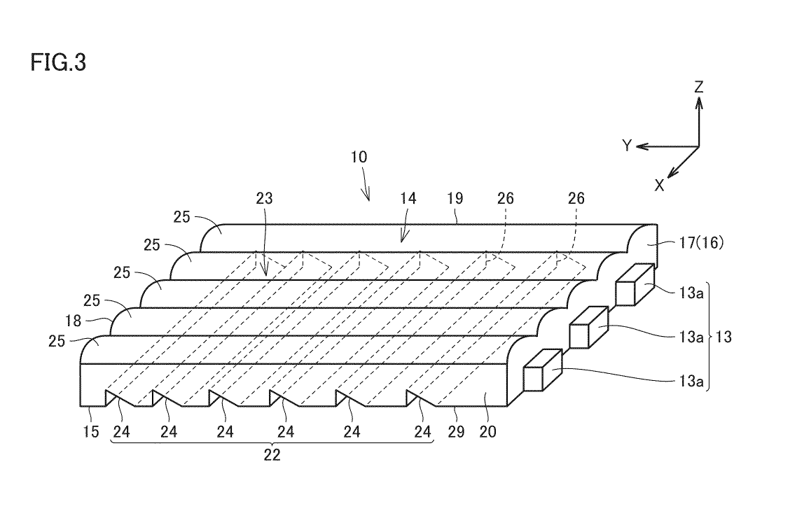

FIG. 3 is a perspective view showing light guide plate 10. As shown in FIG. 3, light guide plate 10 includes a reflection surface 22 formed on main surface 15 for reflecting light that has entered light guide plate 10 toward main surface 14, and a lens 23 formed on main surface 14 for condensing the light reflected by reflection surface 22 and emitting the light to the outside.

Reflection surface 22 includes a plurality of unit reflection surfaces 24 which are spaced apart from one another from the incident surface 17 side toward the end surface 18 side. Main surface 15 is provided with a plurality of prism grooves 26. Unit reflection surface 24 is part of an inner peripheral surface of prism groove 26.

The plurality of prism grooves 26 and the plurality of unit reflection surfaces 24 are spaced apart from one another from the incident surface 17 side toward the end surface 18 side, and are formed to extend from side surface 19 to side surface 20. Thus, unit reflection surfaces 24 are formed in an elongated manner from the side surface 19 side toward the side surface 20 side. A portion of main surface 15 which is not provided with prism grooves 26 is a flat portion 29 as a flat surface.

Lens 23 includes a plurality of cylindrical lenses 25 which are arranged in a direction from the side surface 19 side toward the side surface 20 side.

While cylindrical lens 25 is formed as a convex lens, it may be formed as a concave lens. While cylindrical lens 25 is formed continuously in an elongated manner from incident surface 17 to end surface 18 in the example shown in FIG. 3, it may be formed intermittently.

Thus, unit reflection surface 24 extends in an X direction and the plurality of unit reflection surfaces 24 are arranged in a Y direction. Cylindrical lens 25 extends in a Y direction and the plurality of cylindrical lenses 25 are arranged in the X direction.

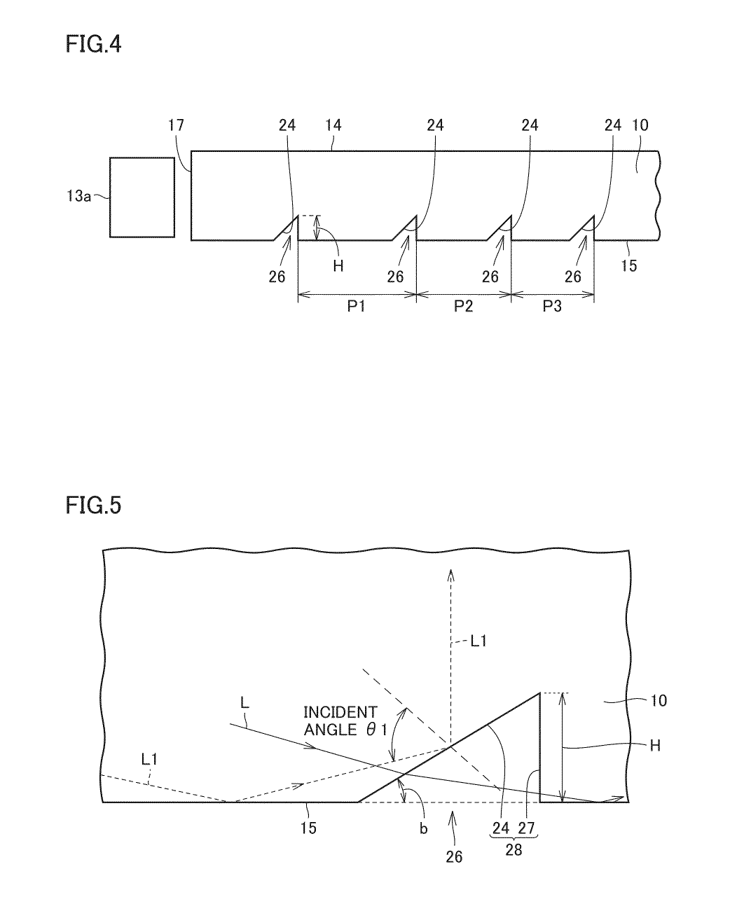

FIG. 4 is a side view showing light guide plate 10 and the light source. As shown in FIG. 4, a portion of the inner surface of prism groove 26 facing incident surface 17 is unit reflection surface 24.

FIG. 5 is a side view showing the details of prism groove 26. As shown in FIG. 5, prism groove 26 is formed substantially in the shape of a right triangle.

An inner surface 28 of prism groove 26 includes unit reflection surface 24, and an inner side surface 27 provided to be connected with unit reflection surface 24. Unit reflection surface 24 and inner side surface 27 form the bottom (apex portion) of prism groove 26, with unit reflection surface 24 being positioned closer to incident surface 17 than the bottom.

As shown in FIGS. 5 and 4, unit reflection surface 24 is inclined away from the main surface 15 side toward the main surface 14 side, from the incident surface 17 side toward the end surface 18 side.

Main surface 15 is provided with an opening by prism groove 26, and inner side surface 27 is formed to be perpendicular to an imaginary plane through the opening. An inclination angle of unit reflection surface 24 relative to the imaginary plane through the opening will be referred to as an inclination angle b.

Light guide plate 10 thus provided with prism grooves 26 and cylindrical lenses 25 is made of, for example, highly transparent resin such as commonly used acrylic or polycarbonate. Light guide plate 10 can be manufactured with a common manufacturing method such as injection molding or imprinting.

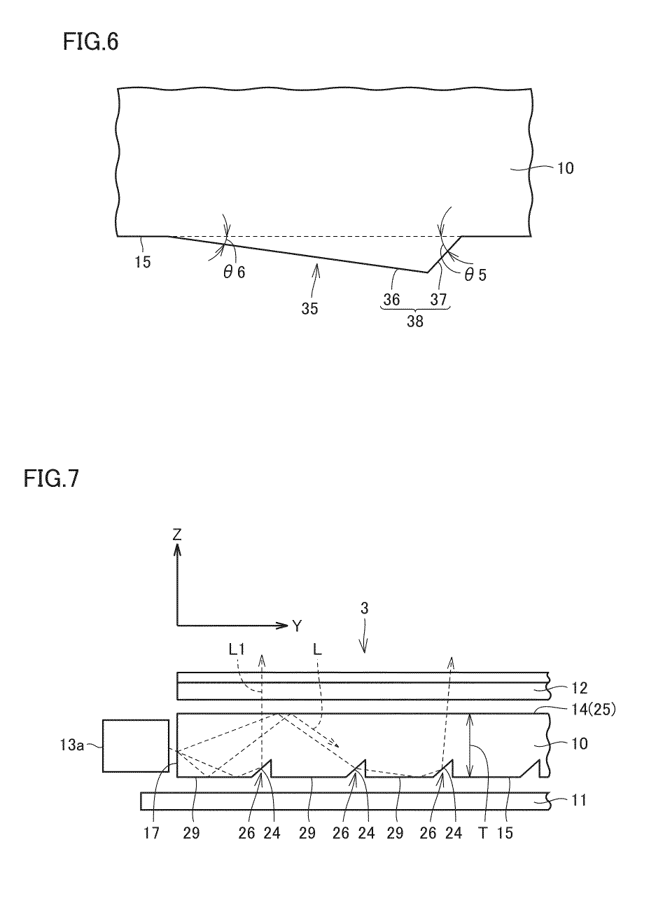

FIG. 6 is a side view showing a variation of unit reflection surface 24 shown in FIG. 5. As shown in FIG. 6, main surface 15 may be provided with a convex portion 35 instead of prism groove 26. A surface 38 of convex portion 35 includes a main surface 36 and a unit reflection surface 37. Unit reflection surface 37 faces incident surface 17 shown in FIG. 2, and is arranged to be able to reflect the light from LED 13a toward main surface 14. Main surface 36 is arranged closer to incident surface 17 than a ridge line portion of convex portion 35 formed of unit reflection surface 37 and main surface 36, and unit reflection surface 37 is arranged closer to end surface 18 than the ridge line portion.

If an inclination angle of unit reflection surface 37 relative to an imaginary plane through main surface 15 is referred to as an inclination angle θ5, a reflection angle of the light can be adjusted by changing inclination angle θ5 as appropriate. Unit reflection surface 37 and unit reflection surface 24 shown in FIG. 5 are not limited to have the shape of a flat surface, but may be concave or convex curved surfaces.

A path of light from LED 13a in backlight unit 3 and liquid crystal display device 1 configured as above is now described.

FIG. 7 is a side view of backlight unit 3. As shown in FIG. 7, LED 13a emits light L which enters light guide plate 10 from incident surface 17.

At least a portion of light L that has entered light guide plate 10 spreads through light guide plate 10 while being reflected by flat portion 29 of main surface 15 which is not provided with prism groove 26, and by cylindrical lens 25.

FIG. 8 is a cross-sectional view of light guide plate 10, showing a cross section in a position through flat portion 29 between prism grooves 26.

As shown in FIG. 8, cylindrical lens 25 is formed in the shape of a curved surface, and light L that has entered light guide plate 10 is reflected in various directions by the surface of cylindrical lens 25 and diffused in light guide plate 10. Particularly, in FIG. 3, the light is diffused in a direction from side surface 19 toward side surface 20 (X direction) and a direction from side surface 20 toward side surface 19.

As shown in FIG. 7, the surface of cylindrical lens 25 is arranged to be perpendicular to incident surface 17, such that when light L from LED 13a is incident on cylindrical lens 25, an incident angle of light L is prevented from being smaller than a critical angle of cylindrical lens 25.

Consequently, when light L that has entered light guide plate 10 from LED 13a is directly incident on cylindrical lens 25, the emission of light L to the outside from cylindrical lens 25 is suppressed.

Flat portion 29 is arranged such that a crossing angle between flat portion 29 and incident surface 17 is not less than 90°. Consequently, when the light that has entered light guide plate 10 from LED 13a is directly incident on flat portion 29, an incident angle of the light is prevented from being smaller than the critical angle.

Consequently, even when the light is directly incident on flat portion 29 from LED 13a, the light is reflected by flat portion 29 to suppress the emission of the light to the outside.

The incident light from LED 13a travels through light guide plate 10 while being reflected by cylindrical lens 25 and flat portion 29, before being incident on unit reflection surface 24.

After entering light guide plate 10 from LED 13a, light L1 shown in FIG. 7 is reflected by flat portion 29 and is incident on unit reflection surface 24. In FIG. 5, an incident angle θ1 of light L1 is not less than the critical angle at unit reflection surface 24, and light L1 is reflected by unit reflection surface 24. Light L1 reflected by unit reflection surface 24 travels toward cylindrical lens 25, as shown in FIG. 7. With light L1 thus reflected toward cylindrical lens 25 by unit reflection surface 24, the diffusion of the light in the Y direction is suppressed.

As shown in FIG. 7, a portion of light L traveling through light guide plate 10 is incident on unit reflection surface 24 at an incident angle smaller than the critical angle. Light L is not totally reflected by unit reflection surface 24 but enters prism groove 26, before reentering light guide plate 10 from inner side surface 27. As such, reduction in light use efficiency is suppressed.

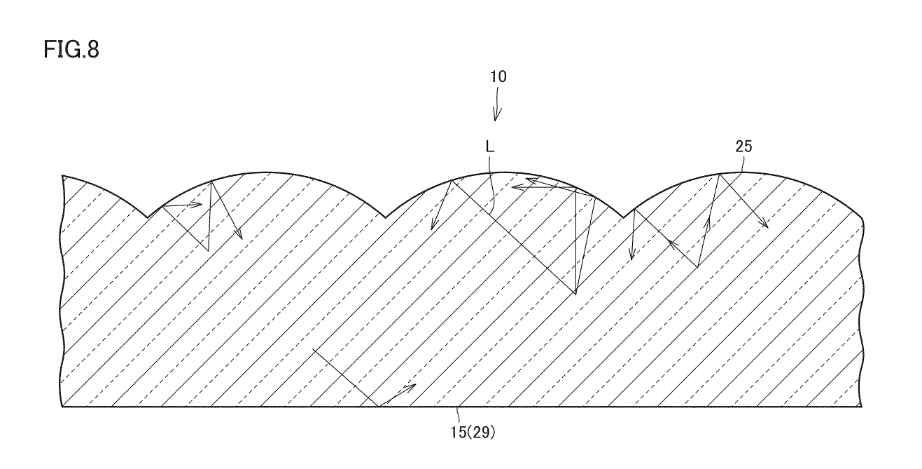

FIG. 9 is a cross-sectional view of light guide plate 10, schematically showing how light L2 travels. As shown in FIG. 9, light L2 reflected by unit reflection surface 24 travels toward cylindrical lens 25. At least a portion of light L2 reflected by unit reflection surface 24 is incident on cylindrical lens 25, and emitted to the outside from cylindrical lens 25 while being condensed by cylindrical lens 25. In FIG. 9 and FIG. 3 above, light L2 emitted to the outside from cylindrical lens 25 is condensed in the X direction.

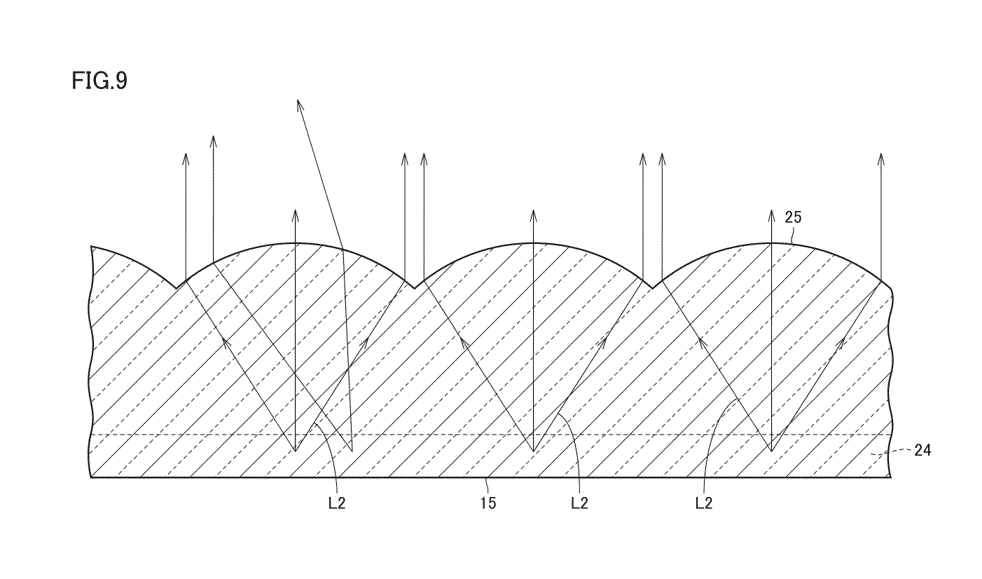

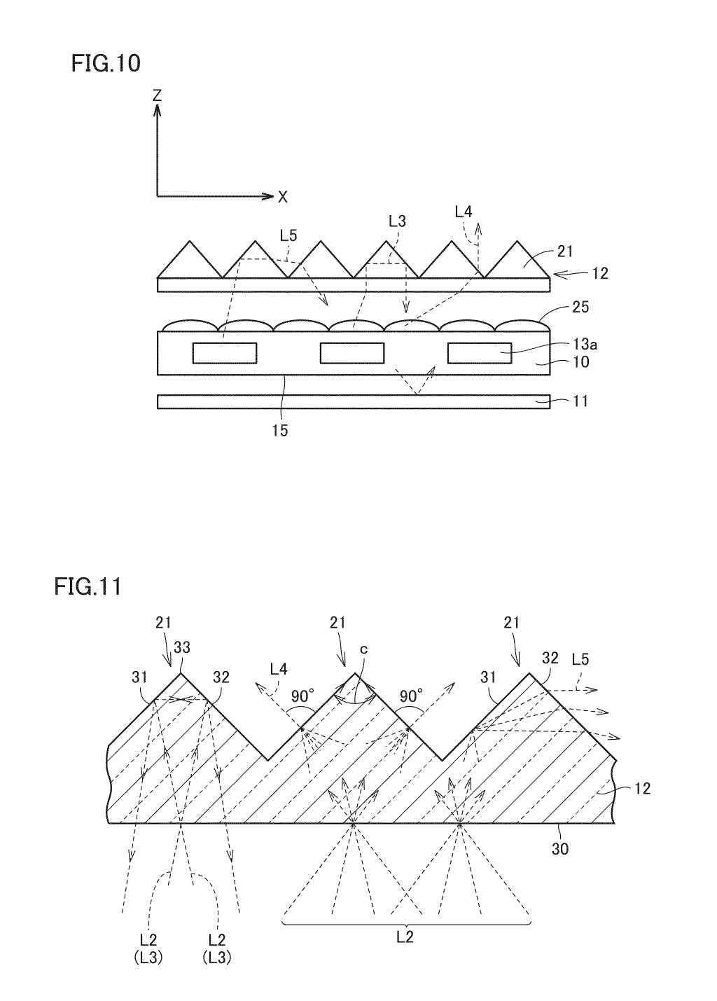

FIG. 10 is a side view of backlight unit 3. In FIG. 10, prism sheet 12 returns a portion of the light emitted from cylindrical lens 25 to light guide plate 10, and emits the light emitted from cylindrical lens 25 toward liquid crystal display panel 2 shown in FIG. 1.

FIG. 11 is a cross-sectional view showing prism sheet 12. Prism sheet 12 includes a main surface 30 through which light L2 enters, and the plurality of prisms 21 formed on a main surface opposite to main surface 30.

Each prism 21 includes a side surface 31, a side surface 32, and a ridge line 33 formed of side surface 31 and side surface 32. An apex angle c between side surface 31 and side surface 32 is, for example, approximately 90°.

As shown in FIG. 11, of light L2, light L3 incident on main surface 30 at angles of 90° and close to 90° is totally reflected by side surfaces 31, 32 of prism 21 and returned to light guide plate 10. Furthermore, light L5 which is a portion of light 2 that has entered prism sheet 12 is totally reflected by one of side surfaces 31 and 32 of prism 21 and emitted to the outside from the other of side surfaces 31 and 32. Subsequently, as shown in FIG. 10, light L5 enters prism sheet 12 from side surfaces 31, 32 of another adjacent prism 21, and is refracted by side surfaces 32, 31 of this prism 21 and returned to light guide plate 10.

Light L3 and L5 returned to light guide plate 10 is reflected again in light guide plate 10. By returning a portion of light L2 emitted from light guide plate 10 into light guide plate 10 in this manner, the light is distributed substantially uniformly through light guide plate 10. The light is then reflected again toward prism sheet 12 by unit reflection surface 24 shown in FIG. 5 and the like. As such, the occurrence of luminance variation can be suppressed in liquid crystal display device 1 to provide uniform surface emission. As shown in FIG. 10, reflection sheet 11 is provided on main surface 15 of light guide plate 10. Reflection sheet 11 reflects leakage of light to the outside from main surface 15 of light guide plate 10 toward light guide plate 10. As such, reduction in light use efficiency is suppressed.

Light L4 which is a portion of light 2 that has entered prism sheet 12 is incident on side surfaces 31, 32 of prism 21 at an incident angle smaller than the critical angle, and emitted from prism sheet 12 toward liquid crystal display panel 2 shown in FIG. 1.

An exit angle of light L4 emitted from prism sheet 12 is not more than 90°, such that an angle between light L4 emitted from prism sheet 12 and an imaginary axis perpendicular to main surface 30 is not more than 45°. Consequently, the diffusion of light L4 in the X direction is suppressed, thereby improving front surface luminance. It is noted that light L3 and L5 not emitted toward liquid crystal display panel 2 in prism sheet 12 is returned to light guide plate 10, to suppress reduction in light use efficiency.

As is clear also from FIG. 2, backlight unit 3 according to this embodiment includes reflection sheet 11, light guide plate 10 and prism sheet 12 laminated on one another. Accordingly, comparing a backlight unit including a reflection sheet, a light guide plate, a diffusion sheet and two prism sheets laminated on one another with backlight unit 3 according to this embodiment, backlight unit 3 according to the third embodiment has a reduced thickness.

In FIG. 4, unit reflection surfaces 24 are arranged such that spaces P1, P2 and P3 between unit reflection surfaces 24 are reduced from the incident surface 17 side toward the end surface 18 side.

The light from LED 13a is emitted conically around the optical axis, with the amount of light incident on unit reflection surface 24 becoming smaller with increasing distance from LED 13a. By reducing the spaces between unit reflection surfaces 24 from the incident surface 17 side toward the end surface 18 side as described above, the occurrence of luminance variation can be suppressed.

It is noted that a height H of unit reflection surface 24 shown in FIG. 5 may be increased from the incident surface 17 side toward the end surface 18 side.

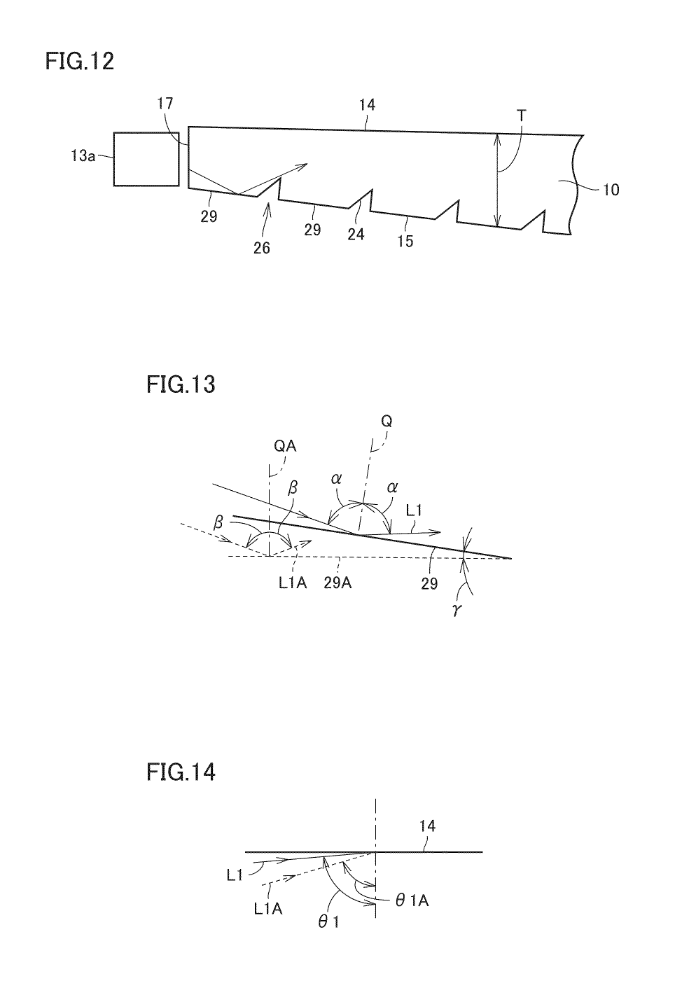

FIG. 12 is a side view showing a variation of light guide plate 10. In this light guide plate 10 shown in FIG. 12, main surface 15 is inclined relative to main surface 14 such that a thickness T of light guide plate 10 is increased.

FIG. 13 is a schematic diagram showing a state where light L1 from LED 13a is reflected by flat portion 29 in FIG. 12. In FIG. 13, an angle γ represents an angle between main surface 14 and main surface 15. An angle between inclined flat portion 29 and main surface 14 is referred to as angle γ.

When light L1 is incident on flat portion 29 at an incident angle α, light L1 is also reflected at a reflection angle α.

Here, flat portion 29 parallel to main surface 14 is referred to as a flat portion 29A. When light L1A, which is parallel to light L1 incident on flat portion 29, is incident on flat portion 29A at an incident angle β and reflected, light L1A is also reflected at a reflection angle β.

FIG. 14 is a schematic diagram showing a state where the reflected light of light L1 shown in FIG. 13 reaches main surface 14 and the reflected light of light L1A reaches main surface 14. As shown in FIG. 14, an incident angle θ1 of light L1 relative to main surface 14 is larger than an incident angle θ1A of light L1A relative to main surface 14. Specifically, there is a relation of the following equation (1) between incident angle θ1 and incident angle θ1A:

Incident angle θ1=incident angle θ1A+2×angle γ (1)

Thus, incident angle θ1 of light L1 becomes larger than the critical angle at main surface 14 by the inclination of main surface 15, thereby suppressing the emission to the outside from main surface 14.

As a result, the light emitted obliquely from main surface 14 can be reduced to improve the front surface luminance of liquid crystal display device 1. Light L1 reflected by main surface 14 is repeatedly reflected in light guide plate 10 until it reaches unit reflection surface 24, thereby suppressing luminance variation.

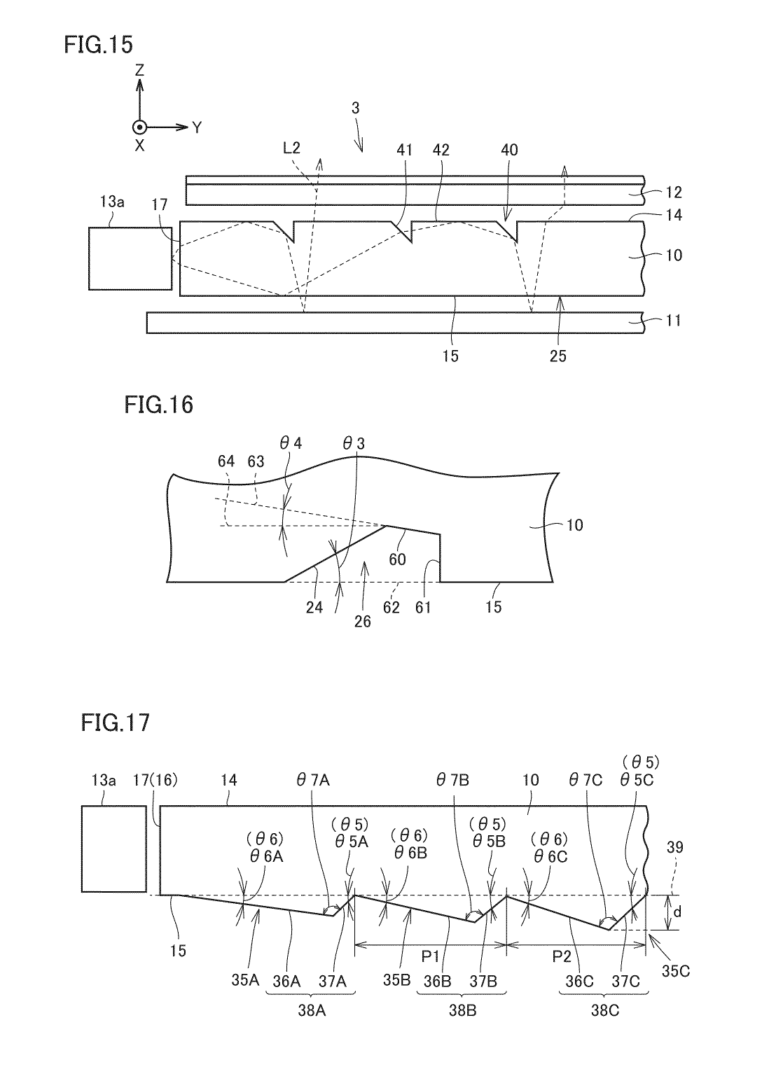

FIG. 15 is a side view showing a variation of backlight unit 3. In this example shown in FIG. 15, main surface 14 of light guide plate 10 is provided with a prism groove 40, and main surface 15 is provided with a cylindrical lens 25.

In this example shown in FIG. 15, a unit reflection surface 41 is formed in a portion of an inner surface of prism groove 40 facing incident surface 17. A portion of main surface 14 which is not provided with prism groove 40 is a flat portion 42 as a flat surface.

Also in this example shown in FIG. 15, the light from LED 13a enters light guide plate 10 from incident surface 17 and is totally reflected by flat portion 42 and cylindrical lens 25. The light is then repeatedly reflected between flat portion 42 and cylindrical lens 25 to be distributed widely through light guide plate 10.

When light L1 is reflected by unit reflection surface 41, resultant reflected light L2 reaches cylindrical lens 25, and is condensed in the X direction and emitted to the outside by cylindrical lens 25.

Light L2 emitted from cylindrical lens 25 is reflected by reflection sheet 11 arranged on the main surface 15 side, before being emitted toward prism sheet 12 from main surface 14. At least a portion of light L2 emitted to prism sheet 12 is condensed in the X direction, and emitted to the outside from prism sheet 12 arranged on the main surface 14 side.

Light L2 from prism sheet 12 is emitted toward liquid crystal display panel 2 shown in FIG. 1.

Thus, also in this example shown in FIG. 15, the light from LED 13a is emitted to liquid crystal display panel 2 while being condensed in the X direction and the Y direction.

While the side (cross-sectional) shape of prism groove 26 is a triangular shape in the examples shown in FIGS. 5, 12 and 15, the side shape of prism groove 26 is not limited to a triangular shape. A shape with a bottom such as a polygonal shape may be employed. FIG. 16 is a side view showing a variation of prism groove 26. In this example shown in FIG. 16, the side shape (cross-sectional shape) of prism groove 26 is a quadrangular shape.

An inner surface of prism groove 26 includes unit reflection surface 24 facing incident surface 17 shown in FIG. 15 and the like, a bottom surface 60 connected with unit reflection surface 24, and an inner side surface 61 positioned opposite to unit reflection surface 24 with respect to bottom surface 60. Prism groove 26 is also formed to extend parallel to incident surface 17, to form an elongated opening in main surface 15.

Prism groove 26 has bottom surface 60, and is formed such that the distance between unit reflection surface 24 and inner side surface 61 is increased from bottom surface 60 toward the opening. By forming prism groove 26 into such a shape, rounding or the tendency to crush of the tip of the prism can be suppressed during release of light guide plate 10 from a mold.

Here, an imaginary plane through the opening of prism groove 26 is referred to as an imaginary plane 62. In addition, an imaginary plane through bottom surface 60 is referred to as an imaginary plane 63. Moreover, an imaginary plane through a ridge line portion formed of bottom surface 60 and unit reflection surface 24, which extends parallel to imaginary plane 62, is referred to as an imaginary plane 64.

An angle between unit reflection surface 24 and imaginary plane 62 is referred to as an inclination angle θ3, and an angle between imaginary plane 63 and imaginary plane 64 is referred to as an inclination angle θ4. As with the shape shown in FIG. 6, it is preferable that inclination angle θ3 be not less than 40 degrees and not more than 50 degrees, and inclination angle θ4 be not more than 5°. The reason for this range for inclination angle θ3 will be described later.

FIG. 17 is a side view showing a variation of convex portion 35 shown in FIG. 6. As shown in this example of FIG. 17, main surface 15 is provided with a plurality of convex portions 35. Main surface 15 is provided with convex portions 35A to 35C in FIG. 17. Convex portions 35A to 35C include main surfaces 36A to 36C and unit reflection surfaces 37A to 37C, respectively. Here, an imaginary plane extending along main surface 15 is referred to as an imaginary plane 39.

An inclination angle of unit reflection surface 37A relative to imaginary plane 39 (angle between imaginary plane 39 and unit reflection surface 37A) is referred to as an inclination angle θ5A. An angle between imaginary plane 39 and main surface 36A is referred to as an inclination angle θ6A. An angle between main surface 36A and unit reflection surface 37A is referred to as a crossing angle θ7A.

Likewise, inclination angles of unit reflection surfaces 37B and 37C relative to imaginary plane 39 are referred to as inclination angle θ5B and θ5C, respectively. Inclination angles of main surfaces 36B and 36C relative to imaginary plane 39 are referred to as inclination angle θ6B and θ6C, respectively. Angles between main surface 36A and unit reflection surfaces 37B and 37C are referred to as crossing angles θ7B and θ7C, respectively.

As is clear also from FIG. 17, inclinations angles θ5 (θ5A, θ5B and θ5C) of convex portions 35A to 35C are set to be increased from incident surface 17 toward the end surface. By setting unit reflection surfaces 37A to 37C of convex portions 35A to 35C in this manner, the light from LED 13a is incident on unit reflection surfaces 37A to 37C at substantially uniform incident angles. Accordingly, when the light from LED 13a is incident on unit reflection surfaces 37A to 37C and reflected toward main surface 14, variation in reflection angle from position to position can be suppressed.

Inclination angles θ6 (θ6A, θ6B and θ6C) of convex portions 35A to 35C are reduced with increasing distance from incident surface 17. On the other hand, crossing angles θ7 (θ7A, θ7B and θ7C) of convex portions 35A to 35C are set to the same angle (e.g., 134°). Unit reflection surfaces 37A to 37C of convex portions 35A to 35C are set to be increased in area with increasing distance from incident surface 17.

As a result, the occurrence of difference between the amount of light incident on unit reflection surface 37C distant from incident surface 17a and the amount of light incident on unit reflection surface 37A close to incident surface 17a can be suppressed, to suppress the occurrence of difference between the amount of light reflected from unit reflection surface 37A and the amount of light reflected from unit reflection surface 37C.

As such, variation in the amount of light emitted from main surface 14 from position to position can be suppressed. Thus, according to light guide plate 10 shown in FIG. 17, variation in exit angle of light emitted from main surface 14 from position to position can be suppressed, and the occurrence of variation in the amount of emitted light from position to position can be suppressed.

Furthermore, pitches P1 and P2 between unit reflection surfaces 37A, 37B and 37C are formed to be reduced with increasing distance from incident surface 17. Consequently, reduction in the amount of light emitted toward prism sheet 12 from main surface 14 with increasing distance from incident surface 17 can be suppressed.

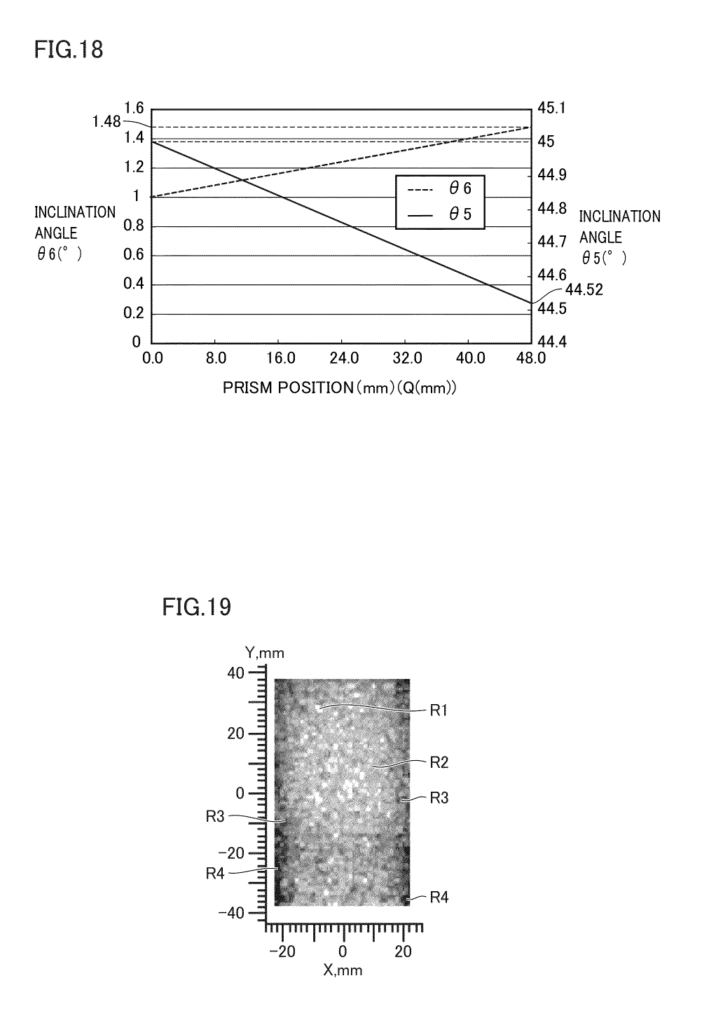

FIG. 18 is a graph showing relation between a distance Q between unit reflection surface 37 and incident surface 17 ((mm):(prism position)), and inclination angle θ6 and crossing angle θ7. The horizontal axis represents the distance between the position of a base portion of unit reflection surface 37 on the main surface 15 side and incident surface 15. The right vertical axis represents inclination angle θ5, and the left vertical axis represents inclination angle θ6. In the graph, inclination angle θ5 is indicated with a solid line, and inclination angle θ6 is indicated with a broken line. Inclination angle θ5 and inclination angle θ6 are represented as a linear function of Q, with the sum of inclination angle θ5 and inclination angle θ6 being set to 46°.

It is noted that FIG. 18 illustrates an exemplary relation with inclination angle θ5 and inclination angle θ6, and the present invention is not limited to the relation shown in FIG. 18.

### EXAMPLES

Referring to FIGS. 19 to 34, examples to which the present invention was applied will be described. FIG. 19 shows a simulation result of the backlight unit model according to this embodiment. As simulation software, “Illumination design analysis software LightTools” (manufactured by CYBERNET SYSTEMS CO., LTD.) was used. In the model used in the simulation shown in FIG. 19, a light guide plate having outer dimensions of 80.88 (mm) (Y direction)×46.96 (mm) (X direction)×0.6 (mm) (Z direction) and a refractive index n=1.59 (which corresponds to that of polycarbonate) was provided with seven LEDs (NSSW006 manufactured by Nichia Corporation) on a short side surface thereof at a pitch of 6.45 mm BEF2-90/24 (apex angle: 90°) was used as the prism sheet, which was arranged to have a ridge line parallel to the Y axis. The reflection sheet was made of a material that causes regular reflection.

As an optical pattern of the light guide plate, the back surface was provided with concave regular triangular prisms each including a main reflection surface having an inclination angle of 48° and a height of 2.5 μm, at pitches that are reduced in stages with increasing distance from the light incident side such that the light is distributed through the light guide plate. The front surface was provided with convex cylindrical lenses (height: 0.01, radius of curvature R: 0.05) having a ridge line parallel to the Y axis continuously at a constant pitch of 0.06 mm.

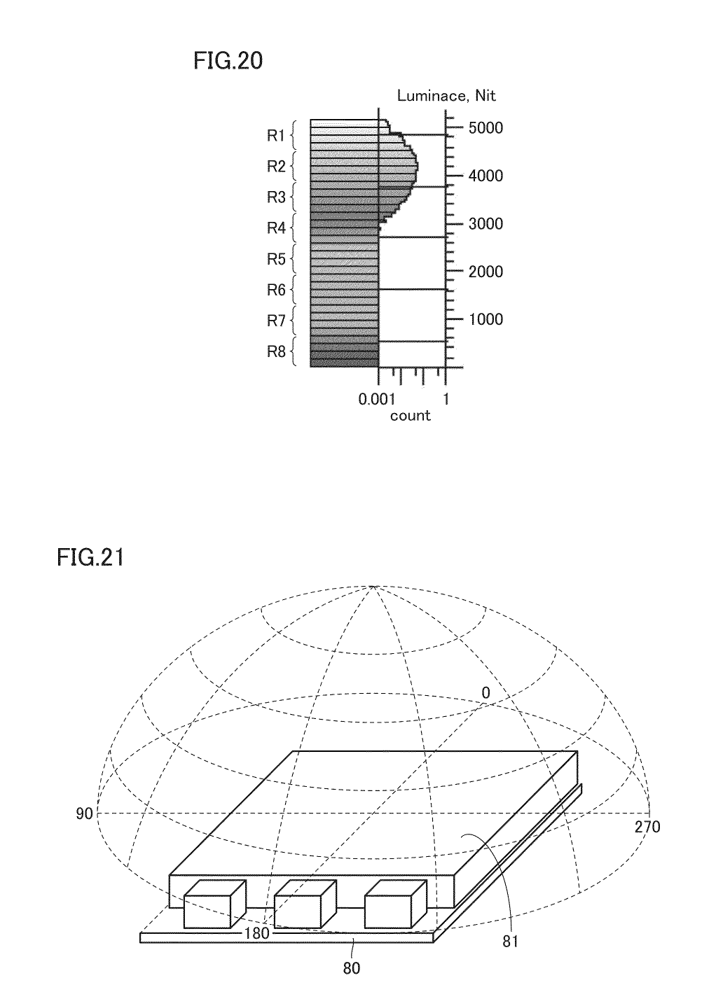

FIG. 19 shows the simulation result illustrating regions of high luminance and low luminance on an exit surface in a model 80 configured as described above. FIG. 20 is a graph showing an area ratio of the regions of high luminance and low luminance in model 80 shown in FIG. 19.

In FIGS. 19 and 20, region R1 represents a region of the highest luminance. The luminance decreases from region R1 toward regions R2, R3, R4, R5, R6, R7 and R8.

First, as shown in FIG. 19, most of the exit surface of model 80 is occupied by regions R1 and R2, with region R3 and region R4 being positioned at the sides of model 80 and in the vicinity thereof.

As is clear also from FIG. 19, it can be seen that luminance variation is suppressed in the exit surface of model 80. Furthermore, as is clear from FIG. 20, it can be seen that regions R1 and R2 of high luminance each have a high area ratio, to provide high luminance across substantially the entire exit surface of model 80.

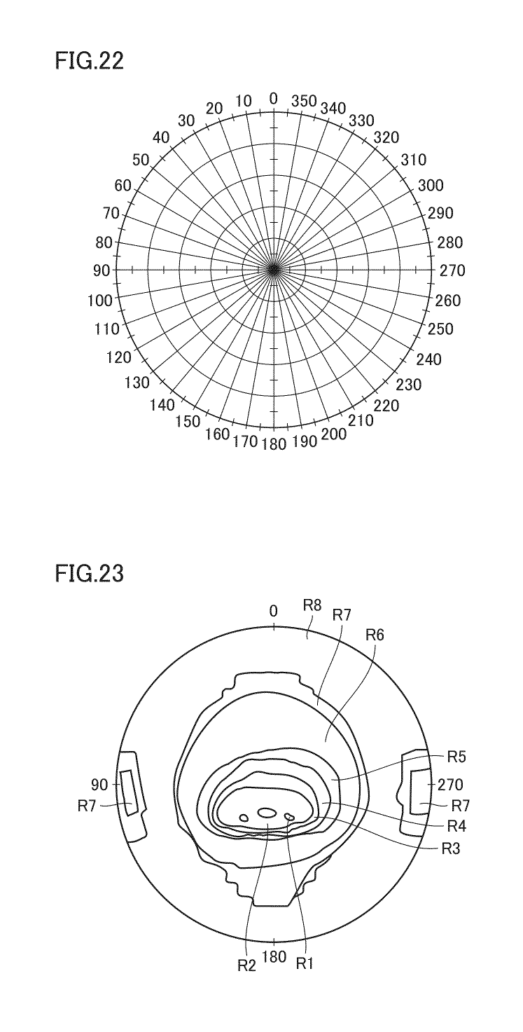

FIG. 21 is a perspective view schematically showing model 80, illustrating a coordinate system that displays the distribution of light exit angles which will be described later. FIG. 22 is a plan view of the coordinate system shown in FIG. 21.

As shown in FIGS. 21 and 22, a hemispherical coordinate is set to cover an exit surface 81 of model 80.

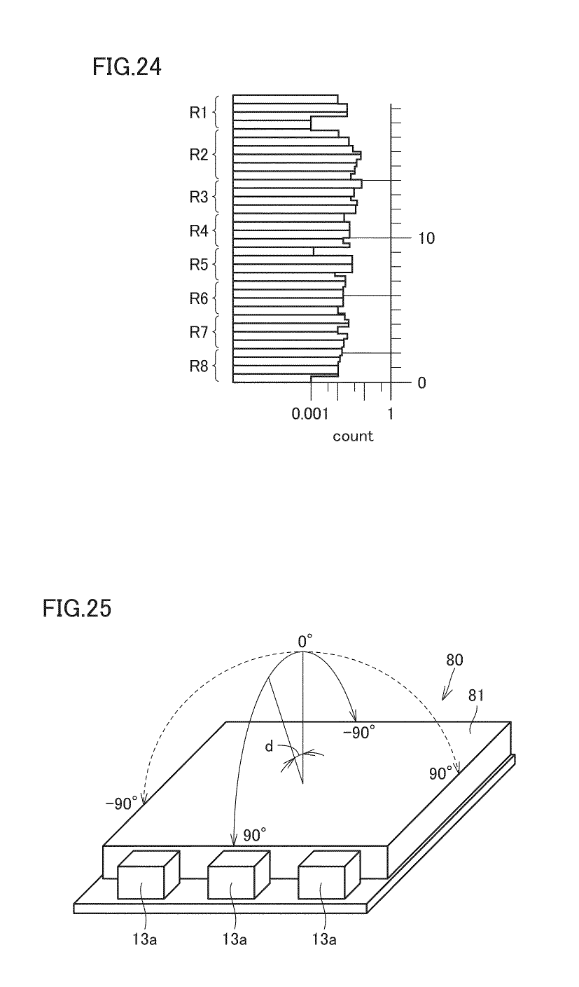

FIG. 23 is a simulation result showing the distribution of exit angles in model 80 shown in FIG. 21. FIG. 24 is a graph showing an area ratio of each luminance. In FIG. 24, the horizontal axis represents an area ratio of each region, and the vertical axis represents the luminance.

It can be seen from FIG. 23 that the luminance is high in a direction perpendicular to exit surface 81 shown in FIG. 21. It can therefore be seen that the front surface luminance of model 80 is increased.

FIG. 25 is a schematic diagram showing a state where a coordinate system other than that shown in FIG. 21 is applied to model 80. In FIG. 25, a view angle d represents an angle with an imaginary axis passing through the center of exit surface 81 and being perpendicular to exit surface 81. The LED 13a side is set to 90°, and the opposite aside is set to −90°.

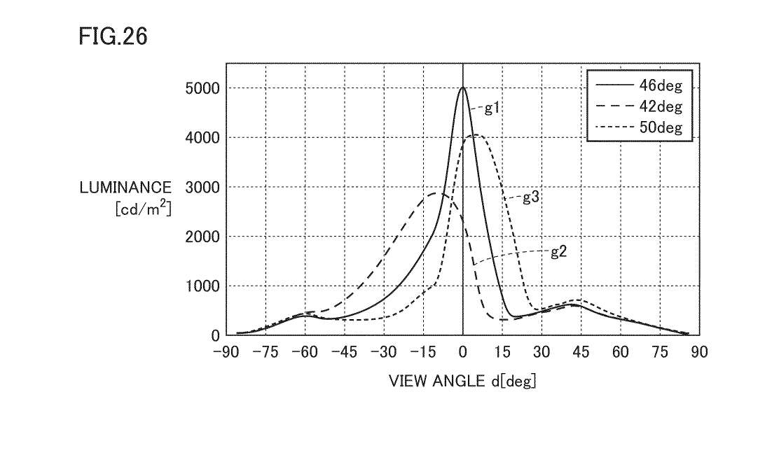

FIG. 26 is a graph showing simulation results of view angle d and luminance, when inclination angle b shown in FIG. 5 was changed. In FIG. 26, the vertical axis represents the luminance, and the horizontal axis represents view angle d.

A graph line g1 in the graph represents a simulation result when inclination angle b shown in FIG. 5 was set to 46° (deg). A graph line g2 represents a simulation result when inclination angle b was set to 42°. A graph line g3 represents a simulation result when inclination angle b was set to 50°.

It can be seen from FIG. 26 that it is preferable to set inclination angle b within a range of not less than 40° and not more than 50°. It can be seen that by setting inclination angle b within such a range, when the light is incident at incident angle θ1 of not less than the critical angle of unit reflection surface 24, light L2 travels perpendicularly or substantially perpendicularly to exit surface 81. Likewise, in the example shown in FIG. 16, it can be seen that it is preferable to set inclination angle θ3 within a range of not less than 40° and not more than 50°.

It is noted that the critical angle of unit reflection surface 24 can be obtained, at an interface between light guide plate (light guide plate material) 10 (refractive index n) and an air layer (n=1.00), as θ=sin−1 (1/n).

Likewise, in the example shown in FIG. 6, it is preferable to set inclination angle θ5 of unit reflection surface 43 relative to the imaginary plane within a range of not less than 40° and not more than 50°.

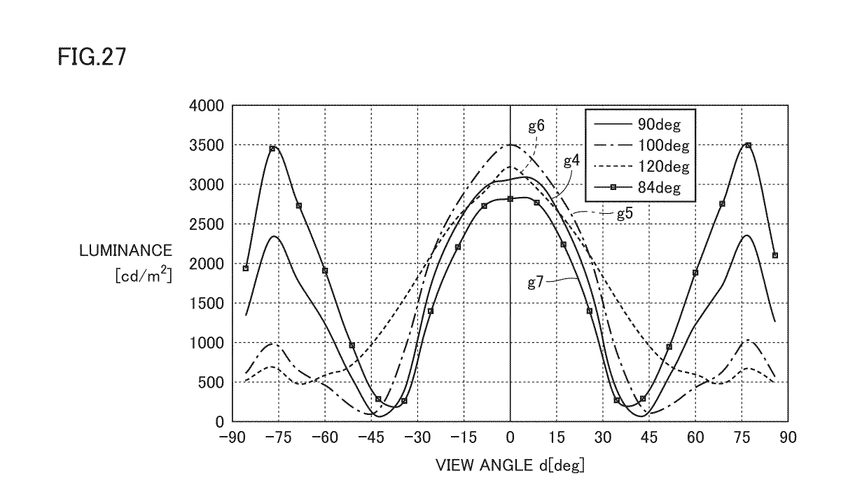

FIG. 27 is a graph showing relation between view angle d and luminance, when apex angle c shown in FIG. 11 was changed as appropriate. The horizontal axis of the graph shown in FIG. 27 represents view angle d, and the vertical axis represents the luminance.

A graph line g4 in FIG. 27 represents a simulation result when apex angle c was set to 90°, and a graph line g5 represents a simulation result when apex angle c was set to 100°. A graph line g6 represents a simulation result when apex angle c was set to 120°, and a graph line g7 represents a simulation result when apex angle c was set to 84°.

It can be seen from the simulation results shown in FIG. 27 that apex angle c of prism 21 is preferably not less than 80° and not more than 120°, and more preferably not less than 90° and not more than 100°.

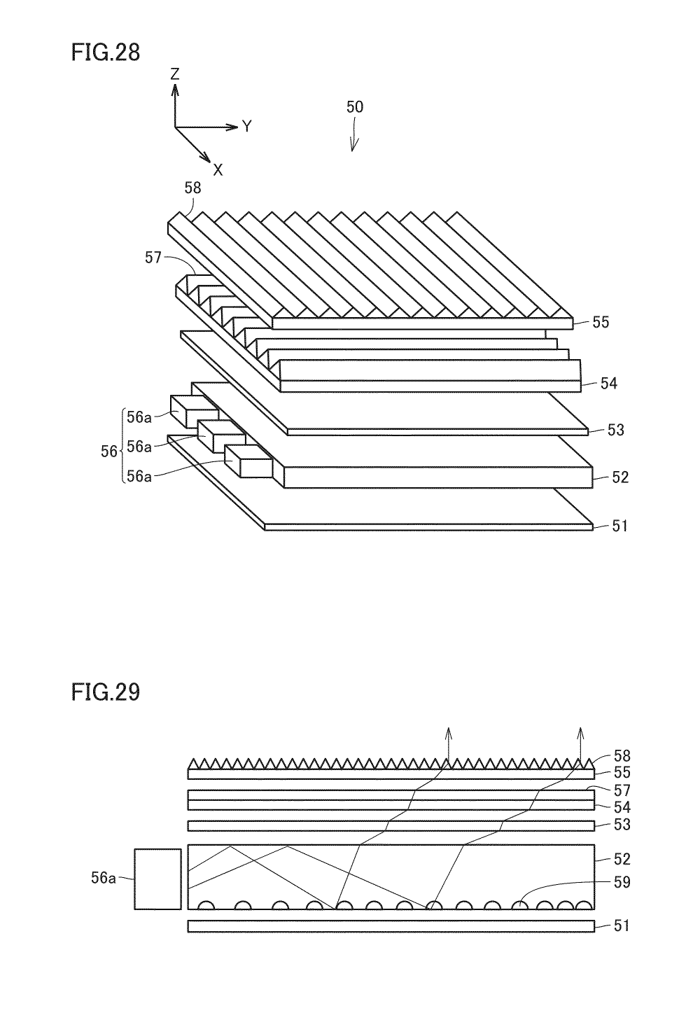

FIG. 28 is an exploded perspective view showing a backlight model 50 as a comparative example. As shown in FIG. 28, backlight model 50 includes a reflection sheet 51, a light guide plate 52 arranged on reflection sheet 51, a diffusion sheet 53 arranged on light guide plate 52, a prism sheet 54 arranged on diffusion sheet 53, and a prism sheet 55 arranged on prism sheet 54.

FIG. 29 is a side view schematically showing backlight model 50 shown in FIG. 28. As shown in FIG. 29, a plurality of dots 59 are formed on a lower surface of light guide plate 52. Dots 59 are formed in a hemispherical shape.

A plurality of prisms 57 are formed on an upper surface of prism sheet 54, and a plurality of prisms 58 are formed on an upper surface of prism sheet 55. Prisms 57 extend in the Y direction and prisms 58 extend in the X direction. A light source 56 including a plurality of LEDs 56a is arranged on a side surface of light guide plate 52.

Light from LEDs 56a enters light guide plate 52 from the side surface of light guide plate 52. The light that has entered light guide plate 52 is repeatedly reflected between the lower surface and upper surface of light guide plate 52 to spread through light guide plate 52. Subsequently, when the light spreading through light guide plate 52 is incident on dots 59, the light is diffusely reflected by dots 59. A portion of the diffusely reflected light travels toward the upper surface of light guide plate 52, before being emitted toward diffusion sheet 53 from the upper surface of light guide plate 52.

The light that has entered diffusion sheet 53 from light guide plate 52 subsequently enters prism sheet 54 and prism sheet 55. Then, the light is emitted to the outside from prism sheet 55.

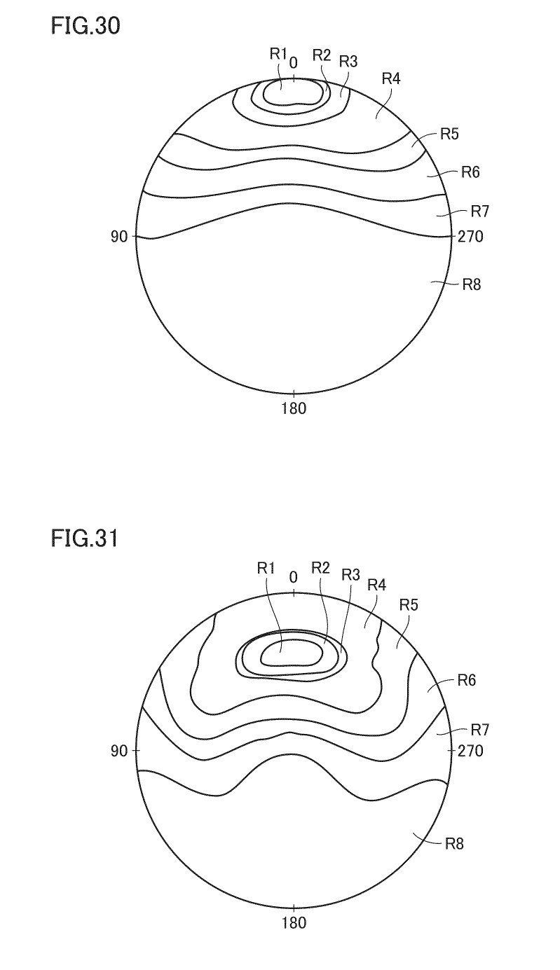

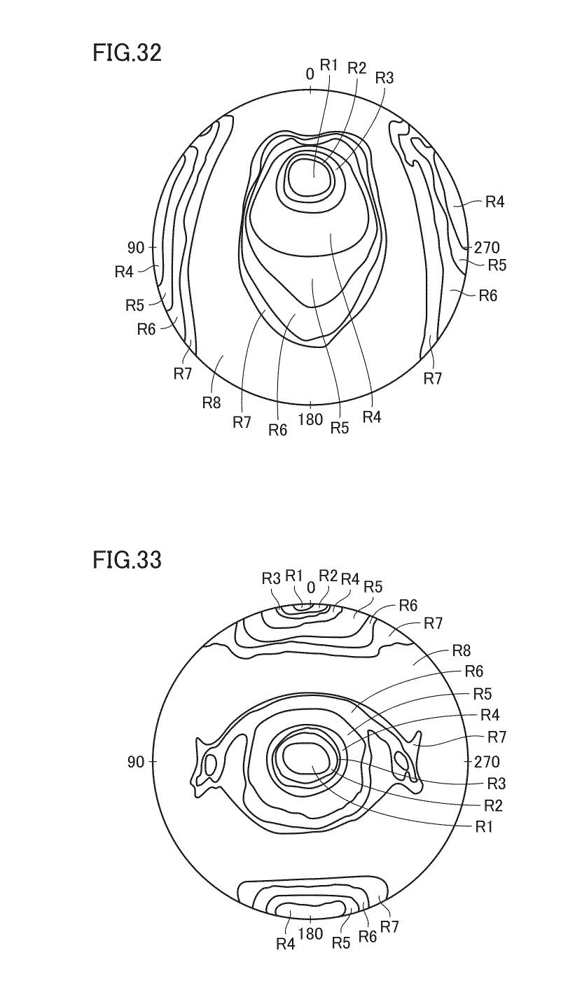

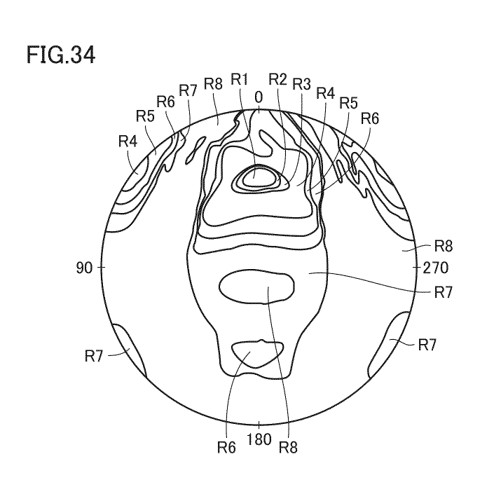

FIG. 30 is an experimental result showing the distribution of exit angles of light emitted from the upper surface of light guide plate 52. FIG. 31 is an experimental result showing the distribution of exit angles of light emitted from diffusion sheet 53. As an experimental apparatus, EzContrast (manufactured by ELDIM), a device for measuring and evaluating the viewing angle characteristics of a display, was employed. FIG. 32 is an experimental result showing the distribution of exit angles of light emitted from prism sheet 54. FIG. 33 is an experimental result showing the distribution of exit angles of light emitted from prism sheet 55. FIG. 34 is an experimental result showing the distribution of exit angles of light emitted from a backlight unit having light guide plate 52 and prism sheet 54 laminated on one another. It is noted that the experimental results shown in FIGS. 30 to 34 are displayed using the coordinate system shown in FIGS. 21 and 22.

First, as shown in FIG. 30, it can be seen that the light emitted from light guide plate 52 contains main components inclined at approximately 70° to 80° relative to the normal of exit surface 81, resulting in low front surface luminance.

It can be seen that the front surface luminance is successively increased by successively laminating diffusion sheet 53, prism sheet 54 and prism sheet 55.

Comparing the experimental result in the comparative example shown in FIG. 33 with the simulation result shown in FIG. 23, it can be seen that the front surface luminance is similarly increased in both cases.

As such, backlight model 50 according to the comparative example and model 80 according to this embodiment are substantially similar to each other in front surface luminance. Meanwhile, unlike backlight model 50 according to the comparative example, model 80 does not include diffusion sheet 53 and prism sheet 55 and is reduced in size in a thickness direction.

Furthermore, comparing the experimental result shown in FIG. 34 with the simulation result shown in FIG. 23, it can be seen that, as illustrated in FIG. 34, the backlight unit including light guide plate 52 and prism sheet 54 laminated on one another has lower front surface luminance than that of model 80 according to this embodiment.

That is, model 80 according to this embodiment can have increased surface luminance while being reduced in unit size.

Although the embodiments and examples of the present invention have been described above, it should be understood that the embodiments and examples disclosed herein are illustrative and non-restrictive in every respect. The scope of the present invention is defined by the terms of the claims, and is intended to include any modifications within the scope and meaning equivalent to the terms of the claims. In addition, the numerical values and the like mentioned above are illustrative and the present invention is not limited to the numerical values and the scopes.

### INDUSTRIAL APPLICABILITY

The present invention relates to backlight units.

### REFERENCE SIGNS LIST

1 liquid crystal display device; 2 liquid crystal display panel; 3 backlight unit; 4 bezel; 5 front bezel; 6 rear bezel; 10, 52 light guide plate; 11, 51 reflection sheet; 12, 54, 55 prism sheet; 13, 56 light source; 14, 15, 30 main surface; 16 peripheral surface; 17 incident surface; 18 end surface; 19, 20, 31, 32 side surface; 21, 57, 58 prism; 22 reflection surface; 23 lens; 24, 37, 41, 43 unit reflection surface; 25 cylindrical lens; 26, 40 prism groove; 27 inner side surface; 28 inner surface; 29, 29A, 42 flat portion; 33 ridge line; 35 convex portion; 36 main surface; 38 surface; 50 backlight model; 53 diffusion sheet.

1-13. (canceled)

14. A backlight unit comprising:
a light source capable of emitting light;
a light guide body including a peripheral surface, the peripheral surface having an incident surface on which the light from said light source is incident and which has a first end portion and a second end portion, a first side surface provided to be connected with said first end portion of said incident surface, a second side surface provided to be connected with said second end portion of said incident surface, and an end surface positioned opposite to said incident surface, and including a first main surface provided to be connected with said peripheral surface, and a second main surface facing said first main surface with said peripheral surface interposed therebetween;
a reflection sheet arranged to face one of said first main surface and said second main surface; and
a prism sheet arranged to face the other of said first main surface and said second main surface, wherein
said first main surface is provided with a plurality of prism grooves extending in a direction from said first side surface toward said second side surface and arranged in a direction from said incident surface toward said end surface,
each of said plurality of prism grooves is formed substantially in the shape of a right triangle in cross section, and includes a unit reflection surface and an inner side surface provided to be connected with said unit reflection surface,
said unit reflection surface is formed to extend from said first main surface toward said second main surface to face said incident surface, and is arranged closer to said incident surface than an apex portion of said prism groove formed of said unit reflection surface and said inner side surface,
said first main surface is provided with an opening by said prism groove, said unit reflection surface having an inclination angle set within a range of not less than 40° and not more than 50° relative to an imaginary plane through said opening,
said second main surface is provided with a plurality of convex or concave cylindrical lenses extending in the direction from said incident surface toward said end surface and arranged in the direction from said first side surface toward said second side surface, and
said prism sheet includes a plurality of prisms formed on a main surface thereof positioned opposite to a main surface thereof facing said first main surface or said second main surface, and extending in the direction from said incident surface toward said end surface.

15. The backlight unit according to claim 14, wherein
the height of said unit reflection surface of each of said plurality of prism grooves is set to be increased in the direction from said incident surface toward said end surface.

16. The backlight unit according to claim 15, wherein
said plurality of unit reflection surfaces are arranged such that spaces between said unit reflection surfaces adjacent to each other are reduced in the direction from said incident surface toward said end surface.

17. The backlight unit according to claim 16, wherein
said first main surface is inclined away from said second main surface in the direction from said incident surface toward said end surface.

18. The backlight unit according to claim 15, wherein
said first main surface is inclined away from said second main surface in the direction from said incident surface toward said end surface.

19. The backlight unit according to claim 14, wherein
said plurality of unit reflection surfaces are arranged such that spaces between said unit reflection surfaces adjacent to each other are reduced in the direction from said incident surface toward said end surface.

20. The backlight unit according to claim 19, wherein
said first main surface is inclined away from said second main surface in the direction from said incident surface toward said end surface.

21. The backlight unit according to claim 14, wherein
said first main surface is inclined away from said second main surface in the direction from said incident surface toward said end surface.

22. The backlight unit according to claim 14, wherein
said reflection sheet is arranged to face said first main surface, and said prism sheet is arranged to face said second main surface.

23. The backlight unit according to claim 14, wherein
said convex or concave cylindrical lenses are continuously formed in the direction from said first side surface toward said second side surface.

24. The backlight unit according to claim 14, wherein
each of said prisms included in said prism sheet has an apex angle set within a range of not less than 80° and not more than 120°.

25. The backlight unit according to claim 14, wherein
each of said prisms included in said prism sheet has an apex angle set within a range of not less than 90° and not more than 100°.

26. A backlight unit comprising:
a light source capable of emitting light;
a light guide body including a peripheral surface, the peripheral surface having an incident surface on which the light from said light source is incident and which has a first end portion and a second end portion, a first side surface provided to be connected with said first end portion of said incident surface, a second side surface provided to be connected with said second end portion of said incident surface, and an end surface positioned opposite to said incident surface, and including a first main surface provided to be connected with said peripheral surface, and a second main surface facing said first main surface with said peripheral surface interposed therebetween;
a reflection sheet arranged to face one of said first main surface and said second main surface; and
a prism sheet arranged to face the other of said first main surface and said second main surface, wherein
said first main surface is provided with a plurality of convex portions projecting from said first main surface, extending in a direction from said first side surface toward said second side surface, and arranged in a direction from said incident surface toward said end surface,
each of said plurality of convex portions is formed in a triangular shape in cross section, and includes a main surface and a unit reflection surface,
said unit reflection surface faces said incident surface, and is arranged closer to said end surface than a ridge line portion of said convex portion formed of said main surface and said unit reflection surface,
said unit reflection surface has an inclination angle set within a range of not less than 40° and not more than 50° relative to an imaginary plane through said first main surface,
said second main surface is provided with a plurality of convex or concave cylindrical lenses extending in the direction from said incident surface toward said end surface and arranged in the direction from said first side surface toward said second side surface, and
said prism sheet includes a plurality of prisms formed on a main surface thereof positioned opposite to a main surface thereof facing said first main surface or said second main surface, and extending in the direction from said incident surface toward said end surface.

27. The backlight unit according to claim 26 wherein
the inclination angle of said unit reflection surface of each of said plurality of convex portions relative to said imaginary plane through said first main surface is set to be decreased in the direction from said incident surface toward said end surface.

28. The backlight unit according to claim 27, wherein
said plurality of unit reflection surfaces are arranged such that spaces between said unit reflection surfaces adjacent to each other are reduced in the direction from said incident surface toward said end surface.

29. The backlight unit according to claim 26, wherein
said plurality of unit reflection surfaces are arranged such that spaces between said unit reflection surfaces adjacent to each other are reduced in the direction from said incident surface toward said end surface.

30. The backlight unit according to claim 26, wherein
said reflection sheet is arranged to face said first main surface, and said prism sheet is arranged to face said second main surface.

31. The backlight unit according to claim 26, wherein
said convex or concave cylindrical lenses are continuously formed in the direction from said first side surface toward said second side surface.

32. The backlight unit according to claim 26, wherein
each of said prisms included in said prism sheet has an apex angle set within a range of not less than 80° and not more than 120°.

33. The backlight unit according to claim 26, wherein
each of said prisms included in said prism sheet has an apex angle set within a range of not less than 90° and not more than 100°.
